(19) United States
(12) Patent Application Publication
(10) Pub. No.: US 2020/0210310 A1
(43) Pub. Date: Jul. 2, 2020

(54) ANALYTICS-BASED ARCHITECTURE COMPLIANCE TESTING FOR DISTRIBUTED WEB APPLICATIONS

(71) Applicant: HEWLETT PACKARD ENTERPRISE DEVELOPMENT LP, Houston, TX (US)

(72) Inventor: Latha Srinivasan, Glen Mills, PA (US)

(21) Appl. No.: 16/233,290

(22) Filed: Dec. 27, 2018

(51) Int. Cl. G06F 11/34; G06F 11/30; G06F 11/07; G06F 9/50

(52) U.S. Cl. CPC G06F 11/3447; G06F 11/3409; G06F 11/3476; G06F 11/3072; G06F 2201/875; G06F 11/079; G06F 11/0793; G06F 9/5072; G06F 2209/508; G06F 11/0778

(57) ABSTRACT

A method includes: accessing a plurality of service side logs containing data pertaining to the performance of a computing system in a data center with respect to infrastructure resource consumption; evaluating the performance for architectural compliance based on the accessed data by comparing request patterns against expected resource usage models in the architectural design to identify departures from the expected resource usage models; and publishing the evaluation results with respect to the identified departures, the evaluation results including details of components, target resource uniform resource identifiers, frequency of usage, and infrastructure resource consumption.

### BACKGROUND

Data centers are repositories for computing facilities used to store and manage large amounts of data. In large data centers, the computing facilities may include computing systems having large and complex hardware and software architectures. These complexities have led to the development of various automated management tools to help system administrators manage the performance of the computing system.

Large scale, distributed computing systems such as those often found in data centers are implemented as loosely coupled components, each serving a distinct functional purpose. Such a design promotes encapsulation and modularity allowing each component to evolve independently of each other to serve business needs. The services themselves vary in terms of the role they play as well as the frequency with which they are invoked. As an example, infrastructure level components such as authentication, authorization, logging, alerting etc. are invoked much more frequently than higher level components that manage logical and physical infrastructure.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a computing system in accordance with one or more examples of the present disclosure.

FIG. 2 illustrates selected portions of a hardware and software architecture of an administrative console first shown in FIG. 1.

FIG. 3 illustrates a method practiced in accordance with one or more examples of the present disclosure.

FIG. 4 illustrates a method practiced in accordance with one or more examples of the present disclosure.

FIG. 5 illustrates a method practiced in accordance with one or more examples of the present disclosure.

FIG. 6 illustrates a method practiced in accordance with one or more examples of the present disclosure.

FIG. 7 illustrates a method practiced in accordance with one or more examples of the present disclosure.

FIG. 8 illustrates a method practiced in accordance with one or more examples of the present disclosure.

FIG. 9 illustrates a computing system in accordance with one or more examples of the present disclosure.

FIG. 10 illustrates a computing system in accordance with one or more examples of the present disclosure.

While examples described herein are susceptible to various modifications and alternative forms, the drawings illustrate specific examples herein described in detail by way of example. It should be understood, however, that the description herein of specific examples is not intended to be limiting to the particular forms disclosed, but on the contrary, the intention is to cover all modifications, equivalents, and alternatives falling within the spirit and scope of the examples described herein and the appended claims.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Large computing systems, such as those under discussion, evolve over time. Older equipment and features may be replaced. New equipment and features may be added. As newer features are added over time, the problem of finding and fixing holistic system level issues that are architecturally inefficient becomes that much harder, snowballing into ever larger technical debt. Another class of issues comes from inefficient database access patterns. As developers continue to rely on generic object relational model (“ORM”) technologies to isolate them from database access details, one often finds that inefficient queries and tables can proliferate which in turn causes significant resource crunch at scale. These issues are difficult to identify and isolate in small scale localized testing.

Experience suggests that it is often difficult to predict upfront which intercomponent interactions are susceptible to misuse in terms of architectural adherence (i.e., architectural anti-patterns) and contribute to issues at scale that are not readily apparent in localized developer testing. This can be particularly problematic in the development of new equipment and/or features and before their release. Many of these issues manifest as system-wide issues that are only identified in large scale testing which takes substantial effort to set up and may be too late depending on the phase in the release cycle when the issues are identified.

In addition, as teams and features evolve over time in a product that is being developed at a rapid release cadence, it is very difficult to train developers adequately to ensure they follow all recommended architectural principles. This issue leads to a “whack-a-mole” effect in terms of finding and fixing a class of issues in one component in one release only to find the same issue showing up in a different component in a different release (an artifact of “cut-and-paste driven” development). Occasionally, components unintentionally making calls at a very high frequency for essentially static data may cause an internal “denial of service” style of invocation that can bring the entire application stack down resulting in downtime for the customer.

Some conventional practice identifies performance variances for the same set of operations under different conditions and highlighting them as potential areas for developers to investigate. Such approaches fall short of identifying potential contributors such as the inefficiencies the solution presented herein provides. Other conventional practice has focused on drawing the entire call graph for a given set of operations but does not go far enough into highlighting performance bottlenecks. Extensions of this approach involve injecting faults into the call graph paths to introduce chaos into the system to simulate environmental degradation but does not highlight areas such as inadequate event storming implementations.

The present disclosure provides a technique by which service side logs such as Apache (HTTP) logs, Request Identifier (“ID”) logs, database logs and system level performance data are used to identify and correlate patterns of inefficiencies that are known to result in increased system load which result in performance and/or availability issues. This data driven approach provides metrics that can be used to highlight issues as well as implement tests that can be used to enforce criteria for code submission, thus facilitating a “shift-left” paradigm towards architectural compliance. The technique helps ensure that architecture compliance will be monitored regularly without any additional overhead and non-compliance will be found early to avoid expensive fixes and trade-offs later on in the release cycle.

More particularly, the technique uses data available in service side logs (such as Apache (HTTP) logs and database logs) to find and highlight inefficient patterns of invocation that are known to cause performance issues. The data driven approach provides easily measurable and understandable metrics that can then be validated once appropriate fixes are made in the components. This approach allows writing gating tests that can exercised as exit criteria for code check-ins which in turn will drive up the quality of the product stack and foster a shift left mindset to test architectural compliance.

One example of such a compliance and enforcement issue alluded to above is for static data such as management appliance network address or software version. As components are initialized, they are expected to retrieve static data such as the management appliance IP address, software version the component is running and cache the software version for future use instead of repeatedly invoking lower level components that provide Representational State Transfer (REST) Application Program Interfaces (APIs) for such data. Any changes to such data are communicated over the eventing infrastructure, thus removing the need for polling. However, components routinely violate this principle resulting in unnecessary polling. By matching the Request Identifiers logged in the Apache logs with component identifiers (“IDs”) logged in the product request logs and correlating them with observed system and process load at the time, one can identify components that are violating the architectural principles around frequency of REST invocations for such interactions.

Another set of examples is environment based: detection of architectural anti-patterns such as failure to implement event storming/burst suppression techniques or net filter rules. By correlating similar/same high frequency incoming events from devices (e.g. port flapping, disk drive notifications) with Apache logs that indicate a high rate of interaction with foundational components such as the alerting service, the presently disclosed technique is able to find and flag issues where architectural guidelines around event suppression techniques have not been implemented adequately. In a similar vein, this solution can also detect patterns where an external agent/plugin sends a very high volume of requests in a short period of time and flag architectural compliance issues around lack of Internet Protocol (“IP”) address based net filter rules to prevent external denial of service style of attacks.

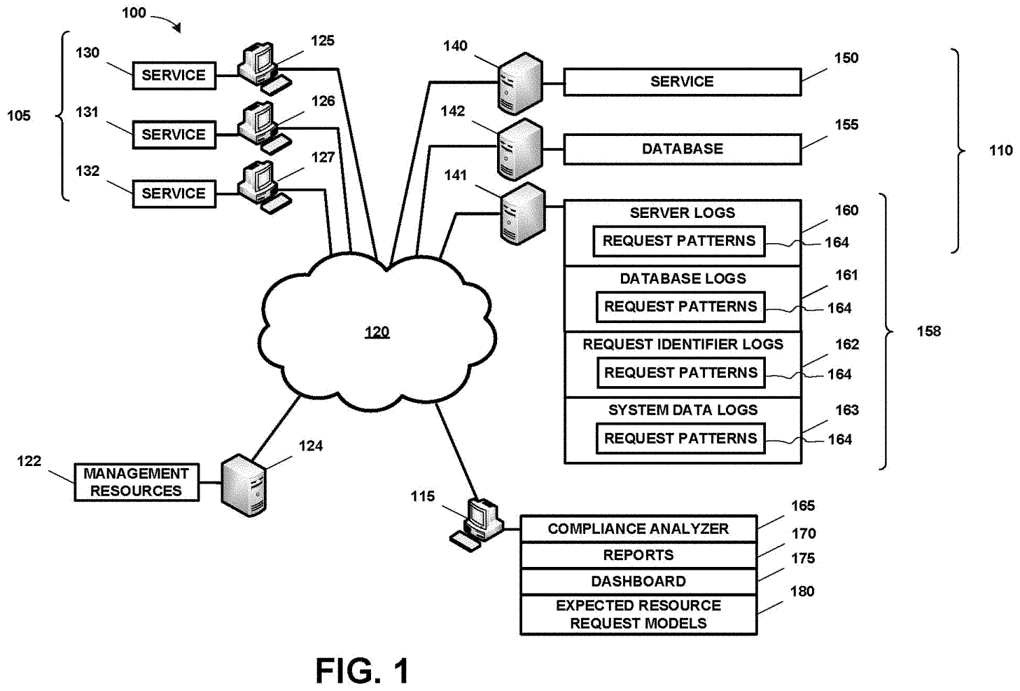

Turning now to the drawings, FIG. 1 illustrates a computing system 100 in accordance with one or more examples of the subject matter claimed below. The computing system 100 is housed in a data center not otherwise shown. The data center may also include support systems such as air conditioning/climate control systems, fire suppression/smoke detection, secure entry and identification and raised floors for easy cabling and water damage prevention. These support systems are not germane to the present disclosure and so are not illustrated for the sake of clarity and so as not to obscure that which is claimed below.

The computing system 100 is a private network housed entirely within the data center. The ports (not shown) of the physical devices are therefore locked down to help prevent unauthorized intrusion of external origination. However, other examples may include portions of, or communicate over, over a public network. One public network that might be included in whole or in part is the Internet and, in particular, the World Wide Web portion of the Internet. In such examples, the ports would need to be unlocked to permit interfacing with the public network.

In this particular example, the computing system 100 is a network operating on a client-server model of communication. The computing system 100 employs the HyperText Transfer Protocol (“HTTP”) and the Transmission Control Protocol/Internet Protocol (“TCP/IP”) to define the architecture thereof. The computing system 100 also employs a distributed web application architecture.

In a distributed web application architecture, components are frequently implemented as distinct services, each serving a separate function. This architectural separation ensures encapsulation and loose coupling between services. In this model, interactions between software components are via 1) Representational State Transfer (“REST”) Application Program Interface (“API”) calls or 2) messages on a message bus (not shown). Note, however, that other examples are not limited to the use of REST and may include some other distributed model protocol using protocols similar to REST over HTTP protocols for inter-component interactions.

The services themselves vary in terms of functionality provided and how often they are invoked. As an example, infrastructure foundation services that provide authorization, authentication, logging, etc. are invoked more often than some others that interact with devices.

The computing system 100 includes a number of interacting entities such as a plurality of users 105, a plurality of servers 110 hosting the application software components, an administrative console 115 interfacing with an internal network 120, and a suite of management resources 122. Those in the art having the benefit of this disclosure will appreciate that the computing system 100 may include any number of physical devices other than those shown. The users 105, servers 110, and administrative console 115 may interface other physical devices not shown such as, for instance, routers, switches, etc. of various kinds. These and other physical devices not shown are omitted for the sake of clarity and so as not to obscure that which is claimed below.

Each component of the computing system 100 (e.g., the servers 110, administrative console 115, physical devices 120-127, etc.) is assigned a Uniform Resource Identifier (“URI”) that uniquely identifies that component within the computing system 100. The URI may be a Uniform Resource Locator (“URL”) or a Uniform Resource Name (“URN”). In the illustrated example, the URIs are URNs, but URLs may be used in other examples.

The computing system 100 may include an architecture that is more complicated than is presented in FIG. 1. For example, many computing systems use a layered architecture such as the Open Systems Interconnect (“OSI”) model. In the OSI model, various aspects of the computing system and its operation are assigned to one of seven “layers”: the physical layer, data link layer, network layer, transport layer, session layer, presentation layer, and application layer. What is shown in FIG. 1 would be the “physical layer” in the OSI model. There are other layered architectures that may be employed in various alternative examples. Similarly, some examples of the computing system 100 may also omit a layered architecture. However, details of the architecture of the computing system 100 at this level have been omitted for the sake of clarity and so as not to obscure that which is claimed below.

The computing system 100 may also be virtualized in some examples. In these examples, physical resources of the physical devices may be allocated to software-implemented “virtual machines” that may be organized into software-implemented “virtual networks”. A virtual machine may include physical resources of multiple physical devices and so may be conceptualized as residing on multiple physical devices. A single physical device may therefore host portions of multiple virtual machines. Similarly, a number of virtual networks may be hosted on the single computing system 100. However, other examples of the computing system 100 may not be virtualized. Thus, details associated with such virtualization are omitted for the sake of clarity and so as not to obscure that which is claimed below.

The users 105 may be, for instance, people operating on the physical devices 125-127. The physical devices 125-127 in various examples may be infrastructure components such as servers, storage, networking components or desktop computers, laptop computers, or mobile devices such as smart phones or tablets, none of which are otherwise shown. The users 105 may also, or alternatively, be software components 130-132 residing on the physical devices 125-127. More typically, the users 105 will be software components 130-132 residing on the physical devices 125-127. The software components 130-132 may be, for instance, without limitation, web browsers or services or third party products.

The servers 110 provide various resources for the computing system 100. Among the servers 110 are a web server 140, a web server 141, and a database server 142. Note that not all resources of the computing system 100 will be servers or even physical devices. They may also include, for example, software components residing on physical devices. For instance, a service 150 resides on the webserver 140 and a database 155 resides on the database server 142 and these also may be resources. A variety of logs containing information about the performance of the computing system 100 reside on the web server 141. These logs include, but are not limited to, server logs 160, database logs 161, Request Identifier logs 162, and system data logs 163.

The server logs 160, database logs 161, Request Identifier logs 162, and system data logs 163 are also known as “service side logs” 158. These logs are representative of the many kinds of service side logs that may be found in various computing system implementations. Their listing is therefore illustrative rather than comprehensive or exhaustive. Furthermore, there are many implementations of server logs 160, database logs 161, Request Identifier logs 162, and system data logs 163 that may be used depending upon the implementation of the computing system 100.

Each of the service side logs 158 includes request patterns 164 for the various resources of the computing system 100 of the type corresponding to the type of the log. For instance, the database logs 162 contain data reflecting requests for access to the contents of the individual databases such as the database 155. These requests can be characterized into patterns in which the database 155 is used. Similarly, the Request Identifier logs 162 contain data reflecting requests for the service 150. These requests also can be characterized into patterns in which the service 150 is used. Thus, each of the service side logs 158 contains data constituting request patterns 164 for the resources of the computing system 100.

More particularly, the Request Identifier logs 162 include uniquely generated identifiers (e.g., e3bed508-3fd4-4862-17fc-8a35a2683bce) of requesters, time stamps (e.g., 2018-12-14 16:21 UTC) for when the requests were made, and source and target component names (e.g., server-resource, power-actuator). Request identifier logs 162 as described here permit identification of who made the request, who received the request and when it was made. Note it does not identify the target component's REST Uniform Resource Indicator (“URI”)—those are in the server logs 160. The system performance data logs 163 are logs that capture system and process level resource utilization data—e.g., how much central processing unit (“CPU”), memory, disk input/output (“10”) is being used. The database logs 161 capture the following: the component running the database query (i.e., requesting access to the database), the time stamp when the query was run, the database query, and the duration of query. The server logs 160 contain the time stamp, the target REST URI, status code (success/failure), response time, and size of response for a request. From this information, a compliance analyzer 165 can determine actual usage patterns indicating the performance of the computing system 100 from an architectural standpoint.

The management resources 122, hosted on a server 124, may be used to manage the resources of the computing system 100. One common example of resource management, for instance, is what is known as “load balancing”. Load balancing attempts to balance the amount of processing across multiple processing resources so that no one processing resource is overburdened. Another form of management controls resources for service, repair, and/or replacement. So, for example, a particular database server 142 might need to be upgraded. The management resources 122 can be used to do this in a controlled fashion. There are many other types of resource management that will become apparent to those in the art having the benefit of this disclosure.

Some of the management resources 122 may be automated in the sense that they take action when triggered by predetermined conditions without the need for human intervention. Some may be manual in the sense that they take action only when directed by a human user. Still others may be automated with manual overrides. The management resources 122 will typically include a plurality of tools combining all of these approaches.

Each of the software components in the computing system 100 will include an Application Program Interface (“API”) that is not separately shown. The software components not only include the software components 130-132, but also the software running the servers 110, the service side logs 158, the compliance analyzer 165, a database of reports 170, a dashboard 180, and a plurality expected resource usage models 180. In this context, an API is a set of a set of protocols, routines, functions and/or commands that facilitate interaction between distinct systems. APIs act on behalf of the software component with which they are associated and, so, in discussion are subsumed in the concept of the software component. When a source component requests resource data from a target component that will service the request, the source and target components communicate through their respective APIs.

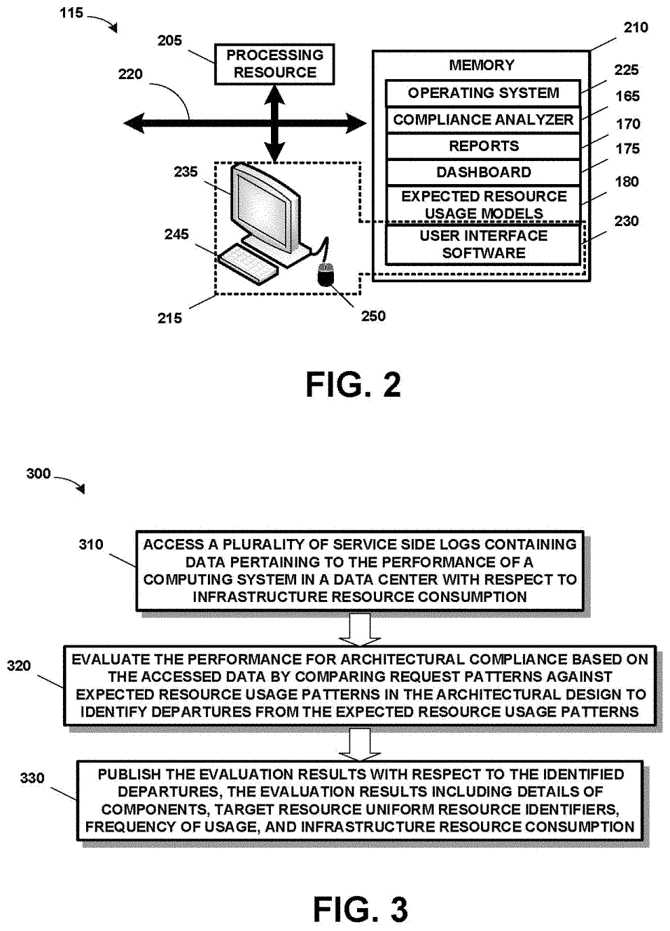

In this particular example, the administrative console 115 hosts a compliance analyzer 165, a plurality of reports 170, a dashboard 175, and expected resource usage models 180. Selected portions of the hardware and software architecture of the administrative console 115 are shown in FIG. 2. The administrative console 115 includes a processing resource 205, a memory 210, and a user interface 215, all communicating over a communication system 220. Thus, the processing resource 205 and the memory 210 are in electrical communication over the communication system 220 as are the processing resource and the peripheral components of the user interface 215.

The processing resource 205 may be a processor, a processing chipset, or a group of processors depending upon the implementation of the administrative console 115. The memory 210 may include some combination of read-only memory (“ROM”) and random-access memory (“RAM”) implemented using, for instance, magnetic or optical memory resources such as magnetic disks and optical disks. Portions of the memory 210 may be removable. The communication system 220 may be any suitable implementation known to the art. In this example, the administrative console 115 is a stand-alone computing apparatus. Accordingly, the processing resource 205, the memory 210 and user interface 215 are all local to the administrative console 115. The communication system 220 is therefore a bus system and may be implemented using any suitable bus protocol.

The memory 210 is encoded with an operating system 225, user interface software 230, the reports 170, and the compliance analyzer 165. The user interface software (“UIS”) 230, in conjunction with a display 235, implements the user interface 215. The user interface 215 includes the dashboard 175 displayed on a display 235. The user interface 215 may also include other peripheral I/O devices such as a keypad or keyboard 245 and a mouse 250.

Also residing in the memory 210 of the administrative console 115 is a plurality of expected resource usage models 180. The design of the computing system 100 includes analysis of the expected usage of the resources. These resources may include, for example, the servers 100 and their residents such as the service 150, the database 155, and the service side logs 158. The expected usage ordinarily results from expected requests for use from other parts of the computing system 100—the services 130-132, for instance. The expected usage can be formulated into expected resource usage models that can then later be used to examine actual resource usage in a manner described below.

Expected resource usage models 180 may more particularly be generated based on the design, as opposed to the operation, of the computing system 100 or, alternatively, from selected periods of operation. For REST APIs, the expected resource usage models 180 may be derived by correlating data in the server logs 160 and request identifier logs 162 over a period of time, for instance, an hour or a day. So, if there are 10,000 requests for a target URI that is essentially static (i.e., only one request would be expected), there is an issue. Expected usage models are maintained in the compliance analyzer 165 and contained in a table that looks like representative Table 1 below. Table 1 includes both database and REST API expected usage models for illustrative purposes. The first row contains a target URI whose response is invariant, i.e., never expected to change once set. The second and third rows are examples of data that change at the expected frequency.

TABLE 1
Sample Expected Resource Usage Models in One Example

| | Number | | Static |
|---|---|---|---|
| | of expected | Expected | data |
| URI | requests | frequency | (Yes/No) |
| /rest/appliance/network-address | 1 | N/A | Yes |
| /rest/ris-event-filters | 60 | 120 seconds | No |
| SELECT storagesys0_.Id as Id24_0_, | 5 | 300 seconds | No |
| storagesys0_.Revision as Revision24_0_, | | | |
| storagesys0_.external_id as external3_24_0_, | | | |
| storagesys0_.family as family24_0_, | | | |
| storagesys0_.hostname as hostname24_0_, | | | |
| storagesys0_.username as username24_0_, | | | |
| storagesys0_.total_capacity as total7_24_0_, | | | |
| storagesys0_.provisioned_capacity as provisio8_24_0_, | | | |
| storagesys0_.free_capacity as free9_24_0_, | | | |
| storagesys0_.device_specific_attributes as | | | |
| device10_24_0_, | | | |
| storagesys0_.module_private_attributes as | | | |
| module11_24_0_, | | | |
| storagesys0_.supports_fc as supports12_24_0_, | | | |
| storagesys0_.supports_iscsi as supports13_24_0_, | | | |
| storagesys0_.credentials_uri as credent14_24_0_, | | | |
| storagesys0_.name | | | |

Referring collectively to FIG. 1 and FIG. 2, as discussed above, the administrative console 115 is presented as a stand-alone computing apparatus interfaced with the rest of the computing system 100 through the internal network 120. Also as discussed above, in some examples aspects of the computing system 100 may be virtualized. Thus, in some examples, the processing resource 205 and memory 210 may comprise resources assigned from other computing apparatus even though the user interfaces with the compliance analyzer 165 through the dashboard 175 on the administrative console 115.

Furthermore, the compliance analyzer 165 need not be hosted on the same computing apparatus as is the dashboard 175. The compliance analyzer 165 may be hosted on some other resource of the computing system 100, such as the web server 140. In some examples, the compliance analyzer 165 itself may be distributed across multiple computing resources of the computing system 100. Still further, the compliance analyzer 165 is, in this example, web service but may be implemented in other types of software components-such as an application or a daemon—in other examples. The compliance analyzer 165 is furthermore implemented as a standalone web service that would be integrated into an automatic testing infrastructure. Further, as noted above, the functionality may be distributed across the computing system 100 instead of being collected in a single piece of software.

Still referring to both FIG. 1 and FIG. 2, the processing resource 205 runs under the control of the operating system 225, which may be practically any operating system. The compliance analyzer 165 is invoked by a user through the dashboard 175, the operating system 225 upon power up, reset, or both, or through some other mechanism depending on the implementation of the operating system 225. The compliance analyzer 165, when invoked, performs a method 300 shown in FIG. 3.

Referring collectively to FIG. 1 and FIG. 3, the method 300 begins by accessing (at 310) a plurality of service side logs 150 containing data pertaining to the performance of a computing system in a data center with respect to infrastructure resource consumption. In this context, “data pertaining to the performance of a computing system” includes data regarding the consumption of system resources such as may be found in the service side logs 158. In FIG. 1, the service side logs 158 include the server logs 160, database logs 161, Request Identifier logs 162, and system data logs 163. Which log is accessed depends on the nature of the infrastructure resource whose consumption is being examined. For example, if usage of the database 155 is being examined, then the compliance analyzer 165 may access the database log 161. If the network resource whose usage is being examined is the service 150, then the compliance analyzer may access the request ID log 162.

The compliance analyzer 165 may access the service side logs 158 directly. Alternatively, the content of the service side logs 158 may be dumped and their content accessed through the dumps (not shown). This approach may be useful in examples where the compliance analyzer 165 is housed in another location separate and apart from the rest of the computing system 100. In such examples, the dumps may be electronically transmitted to the compliance analyzer 165 over a public network.

The method 300 continues by evaluating (at 320) the performance for architectural compliance based on the accessed data by comparing request patterns against expected resource usage patterns in the architectural design to identify departures from the expected resource usage patterns. One form of architectural compliance is that actual resource usage match the expected resource usage. The expected resource usage is captured in the expected resource usage models 180. The request patterns are reflected in the data captured by the service side logs 158 indexed by the resource. The compliance analyzer 165 can therefore access the service side logs 158 to retrieve the request patterns 164 for usage of a particular resource, compare the request patterns 164 with the expected resource usage models 180. The comparison will reveal departures in the request patterns 164 from the expected resource usage models 180 that may then be identified as such. The evaluation (at 320) is a comparison between actual and expected usage and can include either ranges of values or fixed values depending on what the target component's REST URI is or whether resource consumption is DB query usage as is described below

The method 300 continues by publishing (at 330) the evaluation results with respect to the identified departures, the evaluation results including details of components, target resource uniform resource identifiers, frequency of usage, and infrastructure resource consumption. In the example illustrated in FIG. 1 and FIG. 2, the evaluation results are published to a user through the dashboard 175 of the administration console 115 in real-time or near real-time. They may also be published in the form of the reports 170 so that the user may retrieve the information at a later time. In some examples the evaluation results may be published by communication to automated management tools that are a part of the management resources 122.

Some examples will then take evaluation results and identify the root causes of the identified departures. Once the root causes are identified in these examples, the identified departures may be mitigated in a manner improving architectural compliance. Table 2 shows some sample data gathered from scale tests using the method herein including the identified root causes where none of the current approaches to testing architectural compliance exist currently.

TABLE 2
Sample Compliance Data in One Example

| | | | System Load | | |
|---|---|---|---|---|---|
| Elapsed | Request URI/ | Number of | Higher than | Compliance | |
| Time | DB query | Requests | expected range? | issue? | Root Cause |
| 1 minute | Appliance | 80-100 | Yes | Yes | Static data: not |
| | network address | | | | more than one call |
| | | | | | on initialization |
| 60 minutes | Appliance | 600 | Yes | Yes | Static data: not |
| | version | | | | more than one call |
| | | | | | in on initialization |
| 1 minute | RIS event | 1000 | Yes | Yes | High polling rate |
| | filters | | | | |
| 1 minute | Storage | 30 | Yes | Yes | Large volume of |
| | refresh query | | | | long running queries |

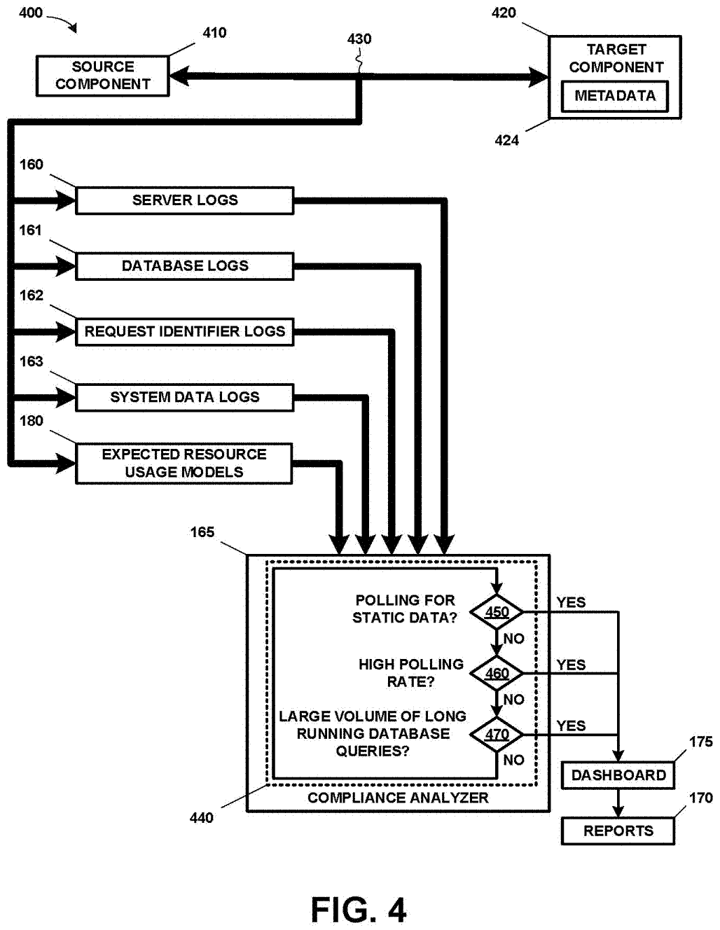

FIG. 4 illustrates one computing system 400 of the computing system 100 in FIG. 1 implementing the method 300 of FIG. 3. In this example, a source component 410 requests usage from a target component 420 using REST over HTTP as described above and as represented by the arrow 430. The source component 410 may be any component of the computing system 100 requesting infrastructure resource consumption and the target component 420 may be any infrastructure resource that may be consumed responsive to a request. For example, in FIG. 1, if the service 150 serves a request from the service 131, then the service 131 is the source component 410 and the service 150 is the target component. The target component 420 is augmented with per URI metadata 424. The URI metadata 424 describes characteristics such as how often the data is expected to change and whether there are alternate event driven mechanisms that provide the same data.

The compliance analyzer 165 calls on the server logs 160, Request Identifier logs 162, system data logs 163, and database logs 161 to evaluate the performance for architectural compliance based on the accessed data by comparing request patterns against expected resource usage models in the architectural design and identify departures from the expected resource usage models 180. The compliance analyzer 165, in this example, performs a method 440. Those in the art having the benefit of this disclosure will appreciate that, in practice, the evaluation will typically be more extensive and more involved. Consequently, the method 440 is instructive rather than comprehensive so as to further an understanding of the claimed subject matter.

The method 440 examines the activity between the source component 410 and the target component 420 as reflected in the server logs 160, Request Identifier logs 162, system data logs 163, and database logs 161. The compliance analyzer 165 evaluates whether, for instance, polling for static data (at 450), the polling rate (at 460), or volume of long running database queries (at 470) depart from the expected resource usage models 180. If any of these evaluations (at 450, 460, 470) detects a departure, the departure is published by communication through the dashboard 175 and inclusion in a report 170.

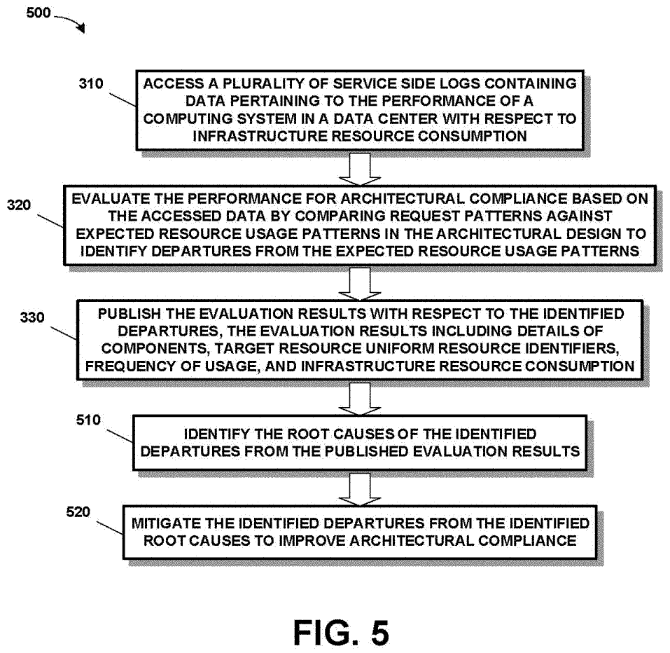

FIG. 5 illustrates an example method 500 that is a variation on the method 300 in FIG. 3. The method 500 includes identifying (at 510) the root causes of the departures from the published evaluation results and mitigating (at 520) the departures from the identified root causes to improve architectural compliance. The identification (at 510) and the mitigation (at 520) will depend on the root cause implicated by the evaluation results in a manner that will be readily understood by those skilled in the art having the benefit of this disclosure.

Referring collectively to FIG. 1 and FIG. 5, the identification (at 510) and/or mitigation (at 520) may be performed by an administrator at the administrative console 115, shown in FIG. 1, using reports published (at 330) through the dashboard 175, also shown in FIG. 1. Alternatively, in some examples, the identification (at 510) and/or mitigation (at 520) may be performed automatically—i.e., without human intervention. For instance, the reports may be published (at 330) to a tool (not shown) in the suite of management resources 122. The tool may include a decision tree and information from a database (not shown) to identify the root cause and a mitigation action. Alternatively, the tool may include an artificial intelligence (not shown) or a neural network (also not shown) that identifies the root cause and a mitigation action. Once the mitigation action is automatically determined, it can then be automatically implemented. Note that some examples may use some combination of manual and automated approaches to identification (at 510) and mitigation (at 520).

The nature of the mitigation action will depend on the root cause. Frequently, mitigation will involve the addition or reallocation of infrastructure resources to alleviate the demands on existing resources that constitute departures from the expected resource usage models. However, the technique herein is not so limited and other mitigation actions be employed where appropriate to the identified root cause. For instance, various load balancing techniques can be used to manage processing resources or resources may be replaced or upgraded.

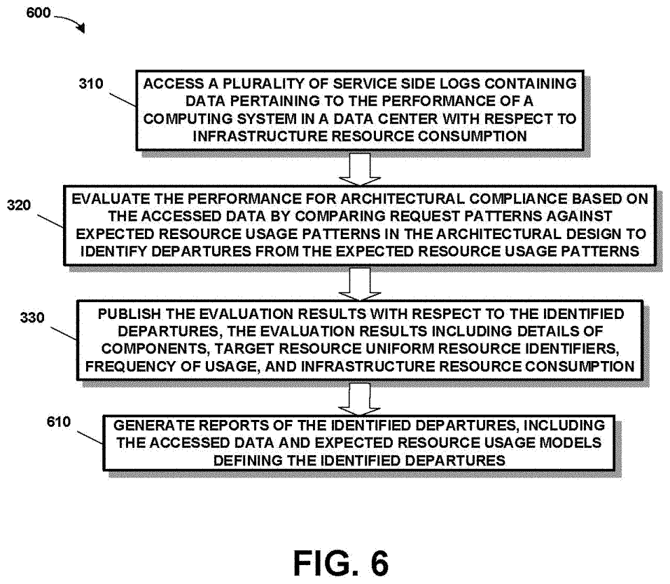

FIG. 6 illustrates a method 600 wherein the method 300 in FIG. 3 is varied by appending report generation (at 610). The reports may be generated and published in real-time or near real-time to the administrative console 115, shown in FIG. 1. They may be stored in, for instance, the database 155, also shown in FIG. 1, or in some other suitable data structure. In one example, the reports include the accessed data and expected resource usage models defining the identified departures.

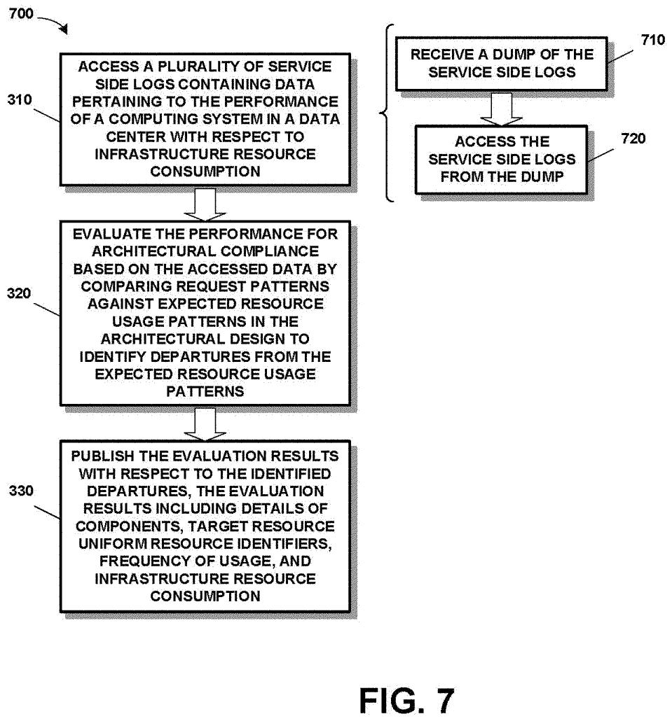

FIG. 7 illustrates a method 700 wherein the accessing (at 310) includes receiving (at 710) a dump of the service side logs and accessing (at 720) the service side logs from the dump. In practice, most examples that dump will periodically dump to storage and the report generation will be performed on the latest dump. As mentioned above, this variation will typically be found in examples in which the evaluation (at 320) and publication (at 330) are performed offsite relative to the computing system 100, shown in FIG. 1. However, the method 700 is not limited to application in such environments.

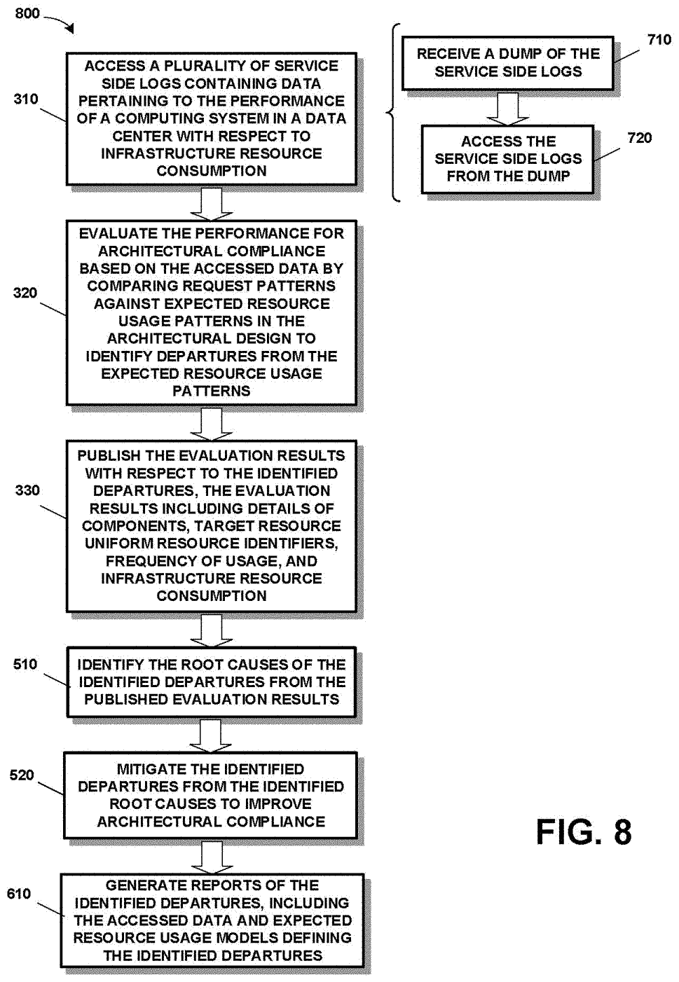

FIG. 8 illustrates a method 800 in which all the variations of FIG. 5-FIG. 8 are employed. Still other examples may use any permutation of the variations in FIG. 5-FIG. 8. Some examples may also employ further variations not expressly disclosed herein but that are within the scope of the appended claims.

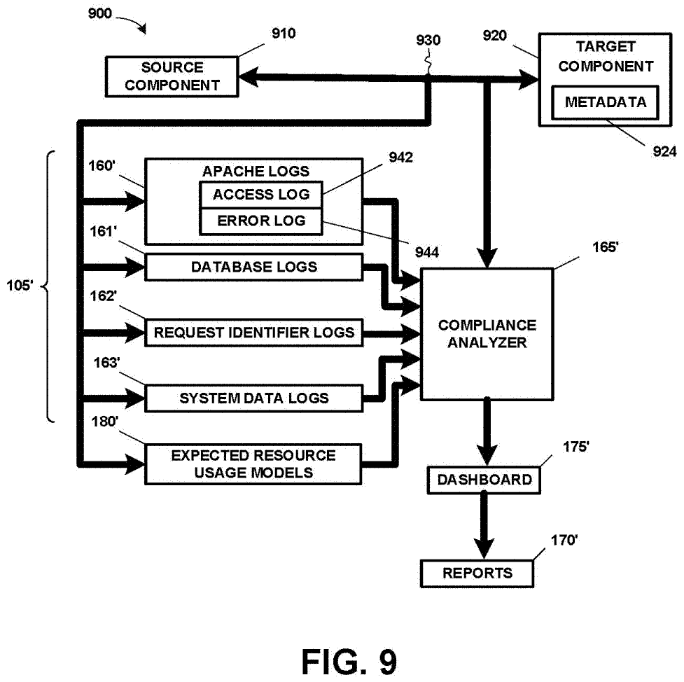

FIG. 9 illustrates a computing system 900. The computing system 900 may be considered a subset of a larger computing system such as the computing system 100 shown in FIG. 1, but this is not necessarily the case in all examples. The computing system 900 includes a source component 910 requesting usage from a target component 920 using REST over HTTP as described above and as represented by the arrow 930. Also included are a plurality of service side logs 105′, a compliance analyzer 165′, an architecture compliance dashboard 175′, and a database of reports 170′.

The source component 910 may be any component of the computing system 900 requesting infrastructure resource consumption and the target component 920 may be any infrastructure resource that may be consumed responsive to a request. For example, in FIG. 1, if the service 150 serves a request from the service 131, then the service 131 is the source component 910 and the service 150 is the target component. The target component 920, as well as other resources within the computing system 900, is assigned a Uniform Resource Identifier (“URI”) and is augmented with per URI metadata 924. The URI metadata 924 describes characteristics such as how often the data is expected to change and whether there are alternate event driven mechanisms that provide the same data.

The service side logs 105′ include Apache logs 940. The presence of the Apache logs 940 in this discussion implies that the target component 920 is a web server running on Apache Web Server Software. Apache Web Server software is an open-source web server software available from Apache Software Foundation and is commonly used in the art for hosting web pages and sites. Apache Web Server Software can support multiple programming languages, server-side scripting, authentication, and virtualization.

The Apache logs 940 record events that occur on Apache web servers-including the target component 920 in this particular example. One example of an Apache log is an access log 942 that includes information about requests coming into, for instance, the target component 920. This information may include, for instance, what pages are requested, the success status of requests, and how long it took the target component 920 to respond to (or “service”) the request. Another example of an Apache log is an error log 944. The error log 944 may contain information about errors that the web server (e.g., the target component 920) encountered when processing requests, such as when files are missing or are otherwise inaccessible. Some aspects of the Apache logs 940 may be modified for any particular implementation. For instance, the Apache Server Software permits modification of what events may be logged.

The Apache logs 940 are disposed on a web server, although not necessarily the web server(s) for which they are logging. Their location within the computing system 900 will depend on a number of well known factors. One such factor is the type of operating system used by the computing system 900. The precise location of the Apache logs 940 within the computing system 900 is not material to the practice of that which is claimed below.

The Request Identifier logs 162′ include information associated with requests made in the computing system 900. This includes the identification of both the source and the target of requests. They therefore include information about both the source component 910 and the target component 920 when the source component 910 requests a service of the target component 920.

Still referring to FIG. 9, the compliance analyzer 165′ is used in finding and highlighting architectural compliance issues such as the examples noted above. The compliance analyzer 165′ takes input from the request identifier logs 162′, system data logs 163′, database logs 161′ and Apache logs 940 to validate if the request patterns found in the Apache logs 940 and the database logs 161′ meet the expected resource usage models 180′. If any patterns are suspicious or correlate with observed high system load, details of components, target resource URIs and frequency is logged in an architecture compliance dashboard from which reports can be generated for trend analysis and defect logging. Thus, combined with the URI metadata 924, the Apache logs 940, and Request Identifier logs 162′, the expected resource usage models 180′ are analyzed by the compliance analyzer 165′ to find and flag issues that fall outside of expected usage patterns. Reports 170′ can be generated to provide historical trends over time.

The evaluation may be a comparison of either ranges or fixed values. For REST invocations, for instance, a range is applicable when the target component 920 has an expected rate of change. If the invocation (polling) is far higher than the rate of change, then that becomes an architectural anti-pattern, or departure from expected resource usage models. An example would be if the target REST URI's value is only expected to change once every 6 hours but the caller is polling every 5 seconds. For fixed values (e.g. management station IP address), the target REST URI does not change once set, but if the source component 910 invokes that URI every 10 minutes, that is also an anti-pattern, or departure from expected resource usage models.

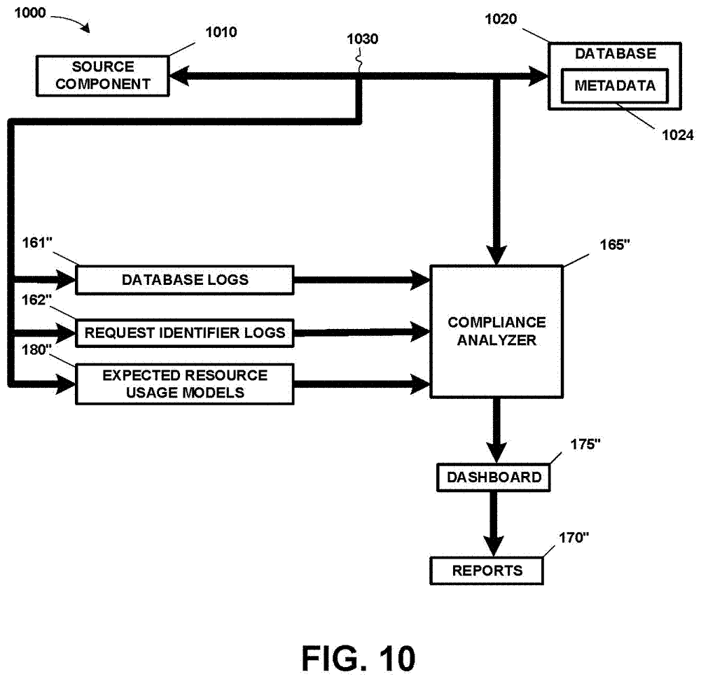

In FIG. 10, the claimed subject matter is applied to interactions with the database layer. In this scenario, data available in database logs is used to analyze queries that are taking over a certain pre-defined threshold and flag them using the compliance analyzer. In addition, one can also use the data to derive understanding of read/write ratios for specific tables which can be used to drive creation of database indexes to speed up queries.

Turning now to FIG. 10, a computing system 1000 is shown. The computing system 1000 may be considered a subset of a larger computing system such as the computing system 100 shown in FIG. 1, but this is not necessarily the case in all examples. The computing system 1000 includes a source component 1010 and a target component—i.e., the database 1020—that communicate using REST over HTTP as described above and as represented by the arrow 1030. The computing system 1000 also includes database logs 161″, a compliance analyzer 165″, a dashboard 175″, and a database of reports 170″.

The source component 1010 may be any component of the computing system 1000 requesting access to the database 1020. For example, in FIG. 1, if the database 155 serves a request for access from the service 131, then the service 131 is the source component 1010 and the service 150 is the target component. The database 1020, as well as other resources within the computing system 1000, is assigned a URI and is augmented with per URI metadata 1024. The URI metadata 1024 describes characteristics such as how often the data is expected to change and whether there are alternate event driven mechanisms that provide the same data.

The compliance analyzer 165″ is then again used to find and highlight architectural compliance issues. The compliance analyzer 165″ takes input from request the database logs 161″ to validate if the request patterns found the database logs 162″ meet the expected resource usage models 180″. If any patterns are suspicious or correlate with observed high system load, details of components, target database queries and frequency is logged in an architecture compliance dashboard from which reports can be generated for trend analysis and defect logging. The expected resource usage models 180″, combined with the URI metadata 1024 and Request Identifier logs 162″ are analyzed by the compliance analyzer 165″ to find and flag issues that fall outside of expected usage patterns. Reports 170″ can be generated to provide historical trends over time.

For database queries, the evaluation is a comparison that typically operates on a range of values. For instance, it may depend on what operations are underway at the time that may query the database 1020. The evaluation measures the proportionality of the database access requests relative to those operations. For instance, the evaluation may measure whether the database query volumes are commensurate with the user-level operation underway.

Thus, in the examples illustrated herein, components are implemented as distinct RESTtful services, each serving a separate function. In this model, components interact with each other using REST over HTTP(s) which promotes loose coupling and modularity. There are no contractual obligations or enforcements around the frequency, mode or nature of interactions between components.

However, as the components scale up in features and numbers and evolve over time, it is difficult to predict upfront which types of inter component interactions are inefficient and cause performance issues which inhibit scale and future evolvability of the application. The solution presented herein provides a set of tools and techniques that can be used to test and validate the architecture for architectural compliance issues (“anti-patterns”) as new features are added over time and to ensure there are no regressions in existing components as they evolve. This approach disclosed herein and claimed below is extensible and allows for addition of new usage patterns as they are found.

The detailed description provided above is set in the context of the development phase for a new product or feature into a data center computing system. However, the technique disclosed herein is not limited to use in the development phase. The technique may be modified or adapted for use in, example, a day-to-day operational environment. The manner in which such modifications or adaptations may be made will become apparent to those skilled in the art having the benefit of this disclosure.

This concludes the detailed description. The particular examples disclosed above are illustrative only, as examples described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular examples disclosed above may be altered or modified and all such variations are considered within the scope and spirit of the appended claims. Accordingly, the protection sought herein is as set forth in the claims below.

What is claimed is:

1. A method comprising:
accessing a plurality of service side logs containing data pertaining to the performance of a computing system in a data center with respect to infrastructure resource consumption;
evaluating the performance for architectural compliance based on the accessed data by comparing request patterns against expected resource usage patterns in the architectural design to identify departures from the expected resource usage patterns; and
publishing the evaluation results with respect to the identified departures, the evaluation results including details of components, target resource uniform resource identifiers, frequency of usage, and infrastructure resource consumption.

2. The method of claim 1, further comprising:
identifying the root causes of the identified departures from the published evaluation results; and
mitigating the identified departures from the identified root causes to improve the architectural compliance.

3. The method of claim 1, further comprising generating reports of the identified departures, the reports including the accessed data and the expected resource usage patterns defining the identified departures.

4. The method of claim 1, wherein the infrastructure resource consumption includes network resources consumption.

5. The method of claim 1, wherein accessing the plurality of service side logs includes at least one of accessing server logs, accessing Request Identifier logs, and accessing database logs.

6. The method of claim 1, wherein a plurality of components of the computing system communicate using Representational State Transfer Application Program Interface calls over HyperText Transfer Protocol connections.

7. The method of claim 1, wherein accessing the plurality of service side logs includes:
receiving a dump of the service side logs; and
accessing the service side logs from the dump.

8. A computing apparatus comprising:
a processing resource; and
a memory in electrical communication with the processing resource;
a compliance analyzer residing in the memory that, when executed by the processing resource, performs a method including:
accessing a plurality of service side logs containing data pertaining to the performance of a computing system in a data center with respect to infrastructure resource consumption;
evaluating the performance for architectural compliance based on the accessed data by comparing request patterns against expected resource usage patterns in the architectural design to identify departures from the expected resource usage patterns; and
publishing the evaluation results with respect to the identified departures, the evaluation results including details of components, target resource uniform resource identifiers, frequency of usage, and infrastructure resource consumption.

9. The computing apparatus of claim 8, wherein the method performed by the compliance analyzer performed further comprises:
identifying the root causes of the identified departures from the published evaluation results; and
mitigating the identified departures from the identified root causes to improve the architectural compliance.

10. The computing apparatus of claim 8, wherein the infrastructure resource consumption includes network resource consumption.

11. The computing apparatus of claim 8, wherein the infrastructure resources include network resources.

12. The computing apparatus of claim 8, wherein accessing the plurality of service side logs includes at least one of accessing server logs, accessing Request Identifier logs, and accessing database logs.

13. The computing apparatus of claim 8, wherein a plurality of components of the computing system communicate using Representational State Transfer Application Program Interface calls over HyperText Transfer Protocol connections.

14. A data center computing system comprising:
a plurality of infrastructure resources;
a plurality of consumers of the infrastructure resources;
a plurality of service side logs that, in operation, record data associated with consumption of infrastructure resources by the consumers;
a compliance analyzer that, in operation, performs the following method:
accessing a plurality of service side logs containing data pertaining to the performance of a computing system in a data center with respect to the infrastructure resource consumption;
evaluating the performance for architectural compliance based on the accessed data by comparing request patterns against expected resource usage patterns in the architectural design to identify departures from the expected resource usage patterns; and
publishing the evaluation results with respect to the identified departures, the evaluation results including details of components, target resource uniform resource identifiers, frequency of usage, and the infrastructure resource consumption.

15. The data center computing system of claim 14, wherein the method performed by the compliance analyzer performed further comprises:
identifying the root causes of the identified departures from the published evaluation results; and
mitigating the identified departures from the identified root causes to improve the architectural compliance.

16. The data center computing system of claim 14, wherein the method performed by the compliance analyzer further comprises generating reports of the identified departures, the reports including the accessed data and expected resource usage patterns defining the identified departures.

17. The data center computing system of claim 14, wherein the plurality of infrastructure resources include network resources.

18. The data center computing system of claim 14, wherein accessing the plurality of service side logs includes at least one of accessing server logs, accessing Request Identifier logs, and accessing database logs.

19. The data center computing system of claim 14, further comprising a plurality of components communicating using Representational State Transfer Application Program Interface calls over HyperText Transfer Protocol connections.

20. The data center computing system of claim 14, wherein accessing the plurality of service side logs includes:
receiving a dump of the service side logs; and
accessing the service side logs from the dump.
